(19) United States
(12) Patent Application Publication
(10) Pub. No.: US 2019/0047316 A1
(43) Pub. Date: Feb. 14, 2019

(54) CYLINDRICAL MOLDED ARTICLE AND BARRIER PLUG, BARRIER PLUG-ATTACHED CONTAINER, AND TUBE FOR STORING INK

(71) Applicant: ASAHI KASEI KABUSHIKI KAISHA, Tokyo (JP)

(72) Inventors: Naoki TAKAGI, Tokyo (JP); Hiromichi TAKAHASHI, Tokyo (JP)

(73) Assignee: ASAHI KASEI KABUSHIKI KAISHA, Tokyo (JP)

(21) Appl. No.: 16/050,422

(22) Filed: Jul. 31, 2018

(30) Foreign Application Priority Data
Aug. 9, 2017 (JP) 2017-154496

(51) Int. Cl. B43K 7/02; B43K 5/02; B32B 1/08; B32B 27/30; B32B 27/22; B32B 37/06

(52) U.S. Cl. CPC B43K 7/02; B43K 5/02; B32B 1/08; B32B 27/30; B32B 27/22; B32B 2323/043; B32B 2270/00; B32B 2597/00; B32B 2264/0228; B32B 2323/10; B32B 37/06

(57) ABSTRACT

It is an object to provide a cylindrical molded article that is also excellent in smell retention properties for smelling substances in addition to oxygen barrier properties and is also excellent in the fine appearance of a cut surface when cut, and a barrier plug, a barrier plug-attached container, and an tube for storing ink each using the same. A cylindrical molded article comprising a cylindrical resin layer comprising a resin having a melting point of 140° C. or more; and a vapor-deposited layer disposed on an outer peripheral surface of the resin layer, the vapor-deposited layer comprising at least one selected from the group consisting of silicon oxide, aluminum oxide, and diamond-like carbon, and the cylindrical molded article having a total thickness of 100 μm or more.

### BACKGROUND OF THE INVENTION

### Field of the Invention

The present invention relates to a cylindrical molded article and a barrier plug, a barrier plug-attached container, and an tube for storing ink.

### Description of the Related Art

Conventionally, containers in various forms are developed, and foods and drinks, seasonings, cosmetics, drugs, and the like are sold filled and packaged in containers. As such containers, particularly various containers to which plugs such as spouts are attached as seen in the packaging of foods and drinks, and various containers to which ports or tubes connected to ports are attached as seen in the packaging of drugs are proposed. Many of all of these plugs, ports, and tubes have tubular structures so as to form flow paths through which the contents of the containers can pass.

For these containers, the contents to be filled are different, but from the viewpoint of the suppression of the degradation of the contents (the maintenance of quality), maintenance in terms of hygiene, and the like, barrier properties such as oxygen barrier properties and water vapor barrier properties are required. Therefore, containers often comprise packaging materials having barrier layers. However, on the other hand, for plugs, ports, and tubes to be attached to containers, it cannot be said that measures to provide barrier properties are sufficiently taken. Therefore, even if a container has barrier properties, it is difficult to say that sufficient barrier properties are ensured in terms of the entire plug-attached container.

Those in which the containers themselves have tubular structures such as tube for storing inks are also in a situation in which it is difficult to say that measures to provide barrier properties are sufficiently taken.

For these problems, some measures to inhibit degradation due to gas transmission and enhance the storage properties are proposed (for example, see Japanese Patent Laid-Open No. 2012-162272, Japanese Patent Laid-Open No. 2006-1623, and Japanese Patent Laid-Open No. 2004-66477).

From the viewpoint of the suppression of the degradation of the contents in a container, and the like, oxygen barrier properties for preventing oxidative degradation, and water vapor barrier properties for preventing drying and moisture absorption degradation are also required, but barrier properties for preventing the flavor, fragrance, and in addition volatile components of contents from flowing out of the container are also important. However, the barrier properties specifically taken as a problem in the above conventional art are oxygen barrier properties and water vapor barrier properties, and it is difficult to say that barrier properties for the components of contents are sufficiently studied.

In order to solve such a problem, attaching a winding of a metal film or the like to the tubular portion of a plug and performing injection molding is also considered. However, in this case, the problem of the intrusion of gases from an adhesive layer and a butt seam sealing portion in winding, and the problem of the cracking of the metal layer arise anew.

In addition, a cylindrical molded article such as a plug requires cutting processing, and in terms of the prevention of the mixing of the resin into contents, and productivity during an additional step after cutting, for example, insert injection molding, it is considered that the fine appearance of the cut surface of the cylindrical molded article is important. Further, a cylindrical molded article such as a plug requires continuous molding, and therefore the stability of molding is important. However, these have not been considered much until now.

The present invention has been made in view of the above problems, and it is an object of the present invention to provide a cylindrical molded article that is also excellent in smell retention properties for smelling substances in addition to oxygen barrier properties and is also excellent in the fine appearance of a cut surface when cut, and a barrier plug, a barrier plug-attached container, and an tube for storing ink each using the same.

### SUMMARY OF THE INVENTION

The present inventors have studied diligently in order to solve the above problems, and as a result found that the above problems can be solved by using a predetermined vapor-deposited layer on a predetermined resin layer, leading to the completion of the present invention.

Specifically, the present invention is as follows.

[1]

A cylindrical molded article comprising:

a cylindrical resin layer comprising a resin having a melting point of 140° C. or more; and

a vapor-deposited layer disposed on an outer peripheral surface of the resin layer,

the vapor-deposited layer comprising at least one selected from the group consisting of silicon oxide, aluminum oxide, and diamond-like carbon, and the cylindrical molded article having a total thickness of 100 μm or more.

[2]

The cylindrical molded article according to [1], wherein the resin constituting the resin layer comprises at least one selected from the group consisting of a polypropylene-based resin, a polyamide-based resin, and a polyethylene terephthalate-based resin, and a tensile modulus of the resin is 800 MPa or more and 3500 MPa or less.

[3]

A method for manufacturing a cylindrical molded article, comprising a vapor deposition step of vapor-depositing at least one selected from the group consisting of silicon oxide, aluminum oxide, and a hydrocarbon on an outer peripheral surface of a cylindrical resin layer comprising a resin having a melting point of 140° C. or more to form a vapor-deposited layer.

[4]

The method for manufacturing a cylindrical molded article according to [3], wherein in the vapor deposition step, the cylindrical resin layer is rotated in a circumferential direction.

[5]

A barrier plug comprising a spout body to be attached to a container, and a cylindrical molded article inserted into the spout body, the cylindrical molded article being the cylindrical molded article according to [1] or [2], the spout body comprising a polyolefin-based resin.

[6]

A barrier plug-attached container comprising a container and the barrier plug according to [5] attached to the container.

[7]

An tube for storing ink for accommodating a writing implement ink, the tube for storing ink being the cylindrical molded article according to [1] or [2].

According to the present invention, it is possible to provide a cylindrical molded article that is also excellent in smell retention properties for smelling substances in addition to oxygen barrier properties and is also excellent in the fine appearance of a cut surface when cut, and a barrier plug, a barrier plug-attached container, and an tube for storing ink each using the same.

### BRIEF DESCRIPTION OF THE DRAWINGS

FIG. 1 shows a cross-sectional view of a cylindrical molded article in this embodiment cut in the axial direction and a cross-sectional view of the cylindrical molded article in this embodiment cut in the direction orthogonal to the axial direction;

FIG. 2 shows a cross-sectional view of a tubular body 10′ in which a laminated film obtained by forming a vapor-deposited layer 1′ on a resin film 2′ is adhered so that the inside of the resin film 2′ and the outside of the vapor-deposited layer 1′ are in contact with each other, and a cross-sectional view of a tubular body 10″ in which a metal film 1″ is wound around the surface of a cylindrical resin layer 2″;

FIG. 3 shows a schematic diagram of a vapor deposition step when a cylindrical resin layer is rotated in the circumferential direction;

FIG. 4 shows a cross-sectional view showing a barrier plug in this embodiment; and

FIG. 5 shows a cross-sectional view showing a writing implement comprising an tube for storing ink in this embodiment.

### DETAILED DESCRIPTION OF THE PREFERRED EMBODIMENT

An embodiment of the present invention (hereinafter referred to as “this embodiment”) will be described in detail below, but the present invention is not limited to this, and various modifications can be made without departing from the spirit thereof.

[Cylindrical Molded Article]

The cylindrical molded article in this embodiment has a cylindrical resin layer comprising a resin having a melting point of 140° C. or more; and a vapor-deposited layer disposed on the outer peripheral surface of the resin layer, the vapor-deposited layer comprises at least one selected from the group consisting of silicon oxide (SiO₂), aluminum oxide (Al₂O₃), and diamond-like carbon, and the cylindrical molded article has a total thickness of 100 μm or more.

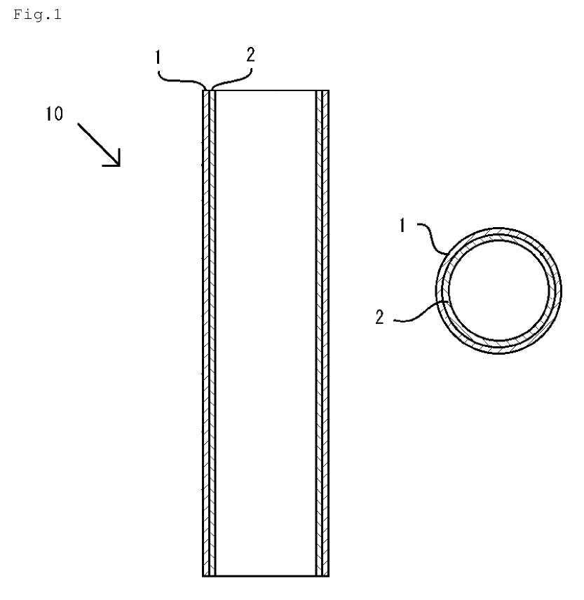

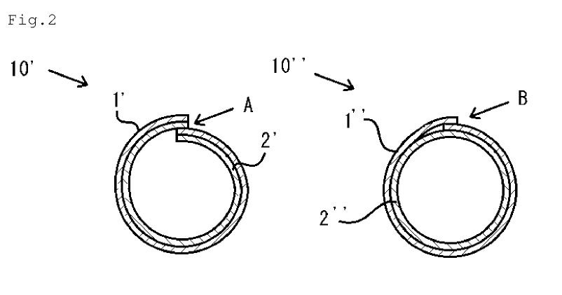

FIG. 1 shows a cross-sectional view of the cylindrical molded article in this embodiment cut in the axial direction and a cross-sectional view of the cylindrical molded article in this embodiment cut in the direction orthogonal to the axial direction. As shown in FIG. 1, the cylindrical molded article in this embodiment 10 has a resin layer 2 that is an inner layer and a vapor-deposited layer 1 that is an outer layer. On the other hand, FIG. 2 shows a cross-sectional view of a tubular body 10′ in which a laminated film obtained by forming a vapor-deposited layer 1′ on a resin film 2′ is adhered so that the inside of the resin film 2′ and the outside of the vapor-deposited layer 1′ are in contact with each other, and a cross-sectional view of a tubular body 10″ in which a metal film 1″ is wound around the surface of a cylindrical resin layer 2″. The tubular bodies 10′ and 10″ as shown in FIG. 2 have portions in which the layers are discontinuous as indicated by the arrows A and B. Therefore, they have poor barrier properties in this respect.

In contrast to this, the cylindrical molded article in this embodiment has the configuration as illustrated in FIG. 1, and thus a portion in which the layers are discontinuous is not present, and therefore the barrier properties are high, and the oxygen transmission rate and water vapor transmission rate of the cylindrical molded article decrease more. The “cylindrical molded article” is not particularly limited as long as it is a tubularly molded molded body comprising a surface vapor-deposited layer and having two or more openings.

By using the cylindrical molded article in this embodiment as a plug for a packaging material, or a plug-attached container, for foods, drugs, or the like, the degradation of foods, drinks, drugs, or the like that dislike the intrusion of gases such as oxygen and water vapor can be prevented, and long-term storage can be allowed while hygiene and safety are kept. In addition, the cylindrical molded article in this embodiment can have stability during extrusion and cross-sectional fine appearance during cutting processing.

### [Vapor-Deposited Layer]

The vapor-deposited layer is disposed on the outer peripheral surface of the resin layer, and when a continuous vapor-deposited layer covers the outer peripheral surface of the resin layer, good barrier properties are exhibited. The vapor-deposited layer comprises at least one selected from the group consisting of silicon oxide, aluminum oxide, and diamond-like carbon and has transparency. Films and tubular molded bodies provided with these transparent vapor-deposited layers are provided with high barrier properties with transparency maintained.

A vapor-deposited layer composed of silicon oxide and/or aluminum oxide can be formed by heating and evaporating silicon oxide or aluminum oxide in a high vacuum state by an electron beam, high frequency induction, or the like and adhering its vapor to the entire surface of the outer periphery of the resin layer. The vapor deposition method is not particularly limited, and generally, examples thereof include methods referred to as a PVD method (Physical Vapor Deposition), a CVD method (Chemical Vapor Deposition), and a PECVD method (Plasma Enhanced Chemical Vapor Deposition).

The method for vapor-depositing diamond-like carbon is not particularly limited, and generally, examples thereof include a CVD method and a PECVD method with a monomer gas alone or mixed with a rare gas.

The thickness of the vapor-deposited layer is preferably 0.01 to 0.6 μm, more preferably 0.02 to 0.1 μm, and further preferably 0.02 to 0.06 μm. When the thickness of the vapor-deposited layer is within the above range, the barrier properties tend to improve more.

### [Resin Layer]

The resin layer is not particularly limited as long as it is a cylindrical one comprising a resin having a melting point of 140° C. or more. Compared with a cylindrical body formed by adhering both ends of a resin film so as to form a cylindrical shape, a cylindrical body having no sealing portion that is molded by extrusion or the like is preferred.

The resin having a melting point of 140° C. or more is not particularly limited, and examples thereof include polypropylene-based resins; polyamide-based resins such as nylon 6, nylon 66, and nylon 12; high density polyethylene-based resins having a melting point of 140° C. or more among high density polyethylene-based resins; polyester-based resins such as polyethylene terephthalate and polybutylene terephthalate; ethylene-vinyl alcohol copolymers; polyvinyl chloride; and polyvinylidene chloride. Among these, polypropylene-based resins, polyamide-based resins, and polyester-based resins are preferred, and polypropylene-based resins, polyamide-based resins, and polyethylene terephthalate-based resins are more preferred. By using such a resin, the adjustment of the thickness of the vapor-deposited layer tends to improve more.

The melting point of the resin constituting the resin layer is 140° C. or more, preferably 150° C. or more, and more preferably 160° C. or more. When the melting point of the resin constituting the resin layer is 140° C. or more, the deformation of the resin layer such as distortion due to heat generated in vapor deposition can be inhibited, and as a result, the dimensional stability of the cylindrical molded article tends to improve more.

Further, the tensile modulus of the resin constituting the resin layer is preferably 800 MPa or more and 3500 MPa or less, more preferably 1000 MPa or more and 2500 MPa or less, and further preferably 1200 MPa or more and 2000 MPa or less. In a case where the tensile modulus of the resin constituting the resin layer is 800 MPa or more, in the step of cutting the cylindrical molded article in this embodiment at a predetermined length, deformation due to impact during cutting can be inhibited, and it is possible to inhibit fissures from occurring in the vapor-deposited layer during cutting to decrease barrier properties. When the tensile modulus of the resin constituting the resin layer is 3500 MPa or less, the occurrence of cracks in the resin layer due to impact during cutting can also be inhibited. In other words, when the tensile modulus is within the above range, the cutting fine appearance tends to improve more. Particularly, when the tensile modulus of the resin constituting the resin layer is 1000 MPa or more and 2500 MPa or less, the processability of the cylindrical molded article in cutting and other processings and the dimensional stability of the cylindrical molded article tend to improve more. When the resin layer is formed using a plurality of resins, the above tensile modulus is a value measured for the whole of the resins constituting the resin layer.

### (Polypropylene-Based Resin)

The polypropylene-based resin (PP) is not particularly limited, and examples thereof include polypropylene homopolymers; and polypropylene copolymers such as random polypropylene and block polypropylene.

### (Polyamide-Based Resin; PA)

The polyamide-based resin is not particularly limited, and examples thereof include aliphatic polyamides, aromatic polyamides, copolymers of aliphatic polyamides with each other, copolymers of aromatic polyamides with each other, and copolymers of aliphatic polyamides and aromatic polyamides.

The aliphatic polyamides are not particularly limited, and examples thereof include polycaproamide (nylon 6), polydodecanamide (nylon 12), polyundecalactam (nylon 11) polytetramethylene adipamide (nylon 46), polytetramethylene sebacamide (nylon 410), polyhexamethylene adipamide (nylon 66), polyundecamethylene adipamide (nylon 116), polyhexamethylene sebacamide (nylon 610), polyhexamethylene dodecamide (nylon 612), polydecamethylene adipamide (nylon 106), polyundecamethylene adipamide (nylon 116), polydecamethylene sebacamide (nylon 1010), and polydecamethylene dodecamide (nylon 1012).

The aromatic polyamides are not particularly limited, and examples thereof include polymetaxylylene adipamide (nylon MXD6), polyparaxylylene adipamide (nylon PXD6), polytetramethylene terephthalamide (nylon 4T), polypentamethylene terephthalamide (nylon 5T), polyhexamethylene terephthalamide (nylon 6T), polyhexamethylene isophthalamide (nylon 61), poly-2-methylpentamethylene terephthalamide (nylon M-5T), polyhexamethylene hexahydroterephthalamide (nylon 6T (H)), polynonamethylene terephthalamide (nylon 9T), polydecamethylene terephthalamide (nylon 10T), polyundecamethylene terephthalamide (nylon 11T), polydodecamethylene terephthalamide (nylon 12T), polybis(4-aminohexyl)methane terephthalamide (nylon PACMT), and polybis(4-aminohexyl)methane isophthalamide (nylon PACMI).

Among these, partially aromatic polyamides such as polymetaxylylene adipamide (nylon MXD6) are preferred from the viewpoint of oxygen barrier properties.

### (High Density Polyethylene-Based Resin; HDPE)

The high density polyethylene-based resin is not particularly limited as long as it is one having a melting point of 140° C. or more among high density polyethylene-based resins. Examples of the high density polyethylene-based resin include high density polyethylene having a density of 0.942 g/cm³ or more.

### (Polyester-Based Resin)

The polyester-based resin is not particularly limited, and examples thereof include polyethylene terephthalate (PET) and polybutylene terephthalate (PBT). Of these, polyethylene terephthalate is preferred.

### (Ethylene-Vinyl Alcohol Copolymer-Based Resin)

The ethylene-vinyl alcohol copolymer (EVOH) is preferred because it is a resin having barrier properties and fills defects such as fissures even if the defects occur in the vapor-deposited layer.

The content of vinyl alcohol in the ethylene-vinyl alcohol copolymer is preferably 35.0 to 60.0 mol %, more preferably 38.0 to 58.0 mol %, further preferably 38.0 to 54.0 mol %, still further preferably 39.0 to 49.0 mol %, and particularly preferably 41.5 to 46.5 mol %. When the content of vinyl alcohol is within the above range, the oxygen non-transmission properties tend to improve more.

The degree of saponification of the ethylene-vinyl alcohol copolymer is preferably 98 to 100 mol %, more preferably 99 to 100 mol %. When the degree of saponification is within the above range, the oxygen non-transmission properties tend to improve more.

### (Other Additives)

The resin layer may comprise other additives such as a known plasticizer, heat stabilizer, colorant, organic lubricant, inorganic lubricant, surfactant, and processing aid as required.

The plasticizer is not particularly limited, and examples thereof include acetyl tributyl citrate, acetylated monoglycerides, and dibutyl sebacate.

The heat stabilizer is not particularly limited, and examples thereof include epoxidized vegetable oils such as epoxidized soybean oil and epoxidized linseed oil, epoxy-based resins, magnesium oxide, and hydrotalcite.

The thickness of the resin layer is preferably 100 to 2000 μm, more preferably 300 to 1500 μm, and further preferably 500 to 1200 μm. When the thickness of the resin layer is within the above range, deformation during vapor deposition tends to be more inhibited.

### [Another Resin Layer]

The cylindrical molded article in this embodiment may have another resin layer (also referred to as a “resin layer II” for convenience) other than the above cylindrical resin layer comprising the resin having a melting point of 140° C. or more (also referred to as a “resin layer I” for convenience). Examples of the resin layer II include a cylindrical resin layer comprising a resin having a melting point of less than 140° C.

As the mode in which the resin layer I and the resin layer II are laminated when the cylindrical molded article has the resin layer II, a tubular body having a two-layer structure having an inside layer and an outside layer, and a tubular body having a three- or more-layer structure having an inside layer, one or more intermediate layers, and an outside layer are considered. The positions of the resin layers in these cases are not particularly limited, and examples thereof include a mode in which the outside layer comprises the resin layer I, and the inside layer comprises the resin layer II; and a mode in which the outside layer comprises the resin layer I, and the intermediate layer and the inside layer comprise the resin layer I or the resin layer II. As described above, the resin layer I comprises the resin having a predetermined melting point from the viewpoint of vapor deposition, and therefore the outside layer in contact with the vapor-deposited layer is preferably the resin layer I.

When the cylindrical molded article has the resin layer II, the resin layer II may be laminated on the further outer periphery of the vapor-deposited layer. In other words, a mode in which the vapor-deposited layer is disposed between the resin layer I and the resin layer II may be used. When the cylindrical molded article has such a configuration, the resin layer II that is the outermost layer tends to improve the ease of attachment of the cylindrical molded article to a bag or a container. It is also possible to use a mode in which instead of the resin layer II, the resin layer I is the outermost layer, and the vapor-deposited layer is disposed between the resin layer I and the resin layer I.

### [Configuration of Cylindrical Molded Article]

The total thickness of the cylindrical molded article is 100 μm or more, preferably 200 μm or more, and more preferably 250 μm or more. The upper limit of the total thickness of the cylindrical molded article is not particularly limited but is preferably 1500 μm or less, more preferably 1000 μm or less, further preferably 700 μm or less, and particularly preferably 600 μm or less. When the total thickness of the cylindrical molded article is not 100 μm or more, the tubular shape cannot be maintained in vapor deposition on the resin layer, and deformation is likely to occur during cutting, and therefore the cutting fine appearance is poor, and a decrease in the barrier properties of the vapor-deposited layer due to deformation can also occur. When the thickness of the cylindrical molded article is within the above range, the self-supporting shape of the cylindrical molded article can be kept, and the cylindrical molded article can be used for more applications and further is excellent in processability and dimensional stability. The total thickness of the cylindrical molded article is thickness including the thickness of the resin layers and the vapor-deposited layer.

The inner diameter of the cylindrical molded article can be appropriately adjusted according to its application, is not particularly limited, and may be a diameter of 1 to 100 mm, or a diameter of 100 mm or more depending on the large container. For example, in the case of a narrow cylindrical molded article used for an tube for storing ink for a ballpoint pen, a highlighter, or the like, one in which the inner diameter of the cylindrical molded article is 1 mm to 5 mm, and the thickness of the cylindrical molded article is 0.3 mm to 2 mm is preferred. For example, in the case of a barrier plug-attached bag and container characterized by being equipped with a barrier plug and sealed, those in which the inner diameter of the cylindrical molded article is 5 mm to 15 mm, and the thickness of the cylindrical molded article is 0.3 mm to 2 mm are preferred.

### [Method for Manufacturing Cylindrical Molded Article]

The method for manufacturing a cylindrical molded article in this embodiment has the vapor deposition step of vapor-depositing at least one selected from the group consisting of silicon oxide, aluminum oxide, and a hydrocarbon on the outer peripheral surface of a cylindrical resin layer comprising a resin having a melting point of 140° C. or more to form a vapor-deposited layer. The method for manufacturing a cylindrical molded article in this embodiment may have the extrusion step of extruding the resin having a melting point of 140° C. or more to mold the cylindrical resin layer, before the above vapor deposition step, as required.

The extrusion method for the cylindrical resin layer is not particularly limited, and a conventionally known method can be used. Also when the cylindrical molded article has the resin layer II, the cylindrical molded article can be manufactured by multilayer extrusion.

The vapor deposition method in the vapor deposition step is not particularly limited, and a known method can be used according to the vapor deposition substance. For example, for the formation of a vapor-deposited layer of silicon oxide or aluminum oxide, generally, examples of the vapor deposition method include methods referred to as a PVD method (Physical Vapor Deposition), a CVD method (Chemical Vapor Deposition), and a PECVD method (Plasma Enhanced Chemical Vapor Deposition). For the formation of a vapor-deposited layer composed of a hydrocarbon (diamond-like carbon), generally, examples of the vapor deposition method include a CVD method and a PECVD method.

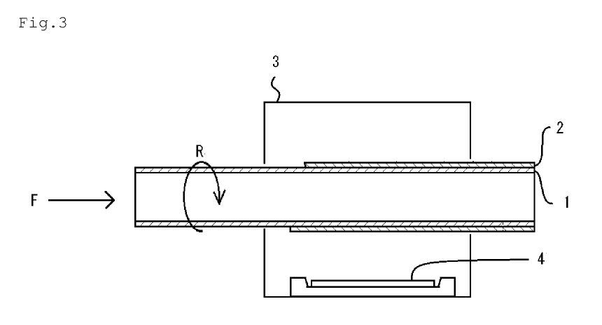

In the vapor deposition step, the cylindrical resin layer is preferably rotated in the circumferential direction. FIG. 3 shows a schematic diagram of a vapor deposition step when a cylindrical resin layer is rotated in the circumferential direction. A tubular resin layer 2 molded by extrusion is fed to a vapor deposition apparatus 3 (the direction of the arrow F). At this time, the resin layer 2 is rotated in the circumferential direction, and thus a vapor deposition substance 4 vaporizes and uniformly adheres to the outer periphery of the resin layer 2, and an even vapor-deposited layer 1 is formed.

The cylindrical molded article obtained by forming the vapor-deposited layer in this manner is cut to a predetermined length and used. For example, when the cylindrical molded article is used for a plug-attached packaging container referred to as a spout-attached pouch or the like, a barrier plug is molded by insert injection molding or the like using the cylindrical molded article in this embodiment, and the barrier plug is attached to a bag and a container. The cylindrical molded article at this time is used with a length reaching the interiors of the bag and the container. When the cylindrical molded article is used for an infusion bag, an insert-injection-molded barrier plug or a tube-like cylindrical molded article is attached by performing heat sealing or the like in a state in which it is sandwiched between the inner surfaces of a bag at an end or corner portion of the bag.

The cylindrical molded article in this embodiment is characterized in that it has a continuous vapor-deposited layer without a bonded site, and the barrier properties are maintained even if it is subjected to hot water treatment such as boiling or retort treatment.

### [Applications]

The cylindrical molded article in this embodiment can be preferably used as a barrier plug and a liquid transport tube provided in a container for accommodating a food or the like, a barrier plug and a liquid transport tube provided in a container for accommodating a drug or the like, and in addition a barrier plug and a liquid transport tube provided in a container for accommodating a product other than a food and a drug, and an tube for storing ink for a ballpoint pen, a highlighter, or the like. In this embodiment, the “container” is not particularly limited as long as it is configured to be able to accommodate contents. A bag and the like are also included in the concept of the container.

### [Barrier Plug]

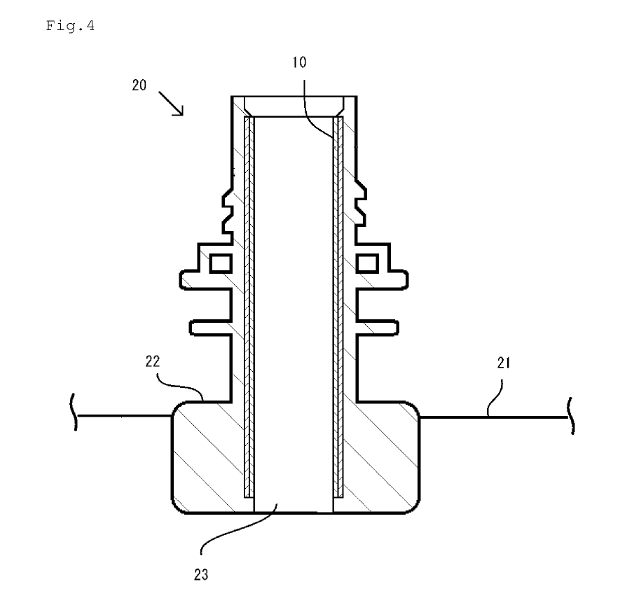

The barrier plug in this embodiment has a spout body to be attached to a container, and a cylindrical molded article inserted into the spout body, the cylindrical molded article is the above cylindrical molded article, and the above spout body comprises a polyolefin-based resin. FIG. 4 shows a cross-sectional view showing a barrier plug. A barrier plug 20 has a spout body 22 to be attached to a container 21, and the above cylindrical molded article 10 inserted into the spout body 22, and the cylindrical molded article forms a discharge flow path 23 for discharging the contents in the container to the outside. Such a barrier plug 20 can be manufactured, for example, by injection-molding the resin constituting the spout body 22 around the cylindrical molded article 10, though not particularly limited.

The resin constituting the spout body is not particularly limited, and examples thereof include polyethylene-based resins (hereinafter also referred to as “PE”) such as low density polyethylene, medium density polyethylene, high density polyethylene, and ethylene-α-olefins; polypropylene-based resins (hereinafter also referred to as “PP”) such as homopolymers or copolymers such as random copolymers and block copolymers; ethylene-vinyl acetate copolymers (hereinafter abbreviated as EVA); polyamide-based resins (hereinafter also referred to as “PA”); and adhesive resins. Among these, polyolefin-based resins are preferred.

### [Barrier Plug-Attached Container]

The barrier plug-attached container in this embodiment has a container and the above barrier plug attached to the container.

The constituent member of the container is not particularly limited, and examples thereof include at least one or more selected from the group consisting of a laminated film having a resin layer having an oxygen transmission rate of 1000 mL·μm/m²·24 hrs·M·Pa (23° C. and 65% RH) or less and a water vapor transmission rate of 1000 g·μm/m²·24 hrs·MPa (38° C. and 90% RH) or less, a laminated film having an aluminum foil layer, and a metal vapor-deposited film. A barrier plug-attached container having such a container and a barrier plug attached to the container is also included in the scope of this embodiment.

The “container” is not particularly limited, and examples thereof include plug-attached containers, plug-attached bags, and plug-attached bottles in which drinks, jellies, seasonings such as soy sauce, or the like are enclosed. Problems of conventional plugs are that they have poor oxygen barrier properties and/or water vapor barrier properties, and therefore even if containers for accommodating foods or the like have oxygen barrier properties and water vapor barrier properties in themselves, oxygen and water vapor passing through the plugs degrade the accommodated product in the packaging, and conversely, the components in the contents of the packaging are released to the outside through the plugs. In a food packaging step, from the viewpoint of sterilization and disinfection, a food to be packaged is enclosed in a container in a heated state, or a container in which a food is enclosed is heated. However, a problem is that when the plug is exposed to water vapor produced from the food or the like in the food packaging step, the barrier properties decrease further. In contrast to this, the barrier plug in this embodiment can inhibit the degradation of a food or the like in packaging by comprising the cylindrical molded article.

### [Tube for Storing Ink]

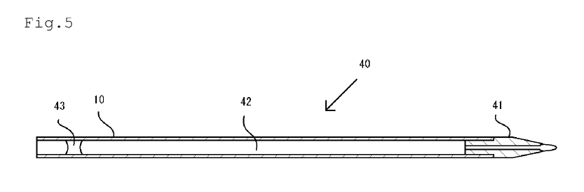

The tube for storing ink in this embodiment is an tube for storing ink for accommodating a writing implement ink, and the tube for storing ink is the above cylindrical molded article. FIG. 5 shows a schematic cross-sectional view showing a writing implement comprising the tube for storing ink in this embodiment. A writing implement 40 comprising the tube for storing ink 10 in this embodiment has a pen point 41 at one end of the tube for storing ink 10 and has a sealing body 43 for enclosing an ink in an ink-accommodating section 42 at the other end. Writing implements include an inner cotton type and a direct liquid type as classification by the structure in the accommodating vessel, and brushes, soft pens, and hard pens as classification by the type of pen point. The tube for storing ink in this embodiment can be used for all. The specific types are not particularly limited, and examples thereof include fountain pens, ballpoint pens, markers, felt-tipped pens, felt pens, calligraphy pens, and refills therefor.

The tube for storing ink can be configured so that by pressurization in the ink-accommodating section 42, the ink is guided to the pen point to allow writing. A problem of conventional tube for storing inks is that they have poor oxygen barrier properties and/or water vapor barrier properties, and therefore the pressure of the space 23 decreases with time. In contrast to this, the tube for storing ink in this embodiment can inhibit the degradation of a drug or the like in packaging by comprising the cylindrical molded article.

### [Liquid Transport Tube]

The liquid transport tube in this embodiment is composed of the above cylindrical molded article. The liquid transport tube forms a discharge flow path for discharging contents in a container to the outside. Its applications are not particularly limited, and examples thereof include those used by being connected to the above foods or medical infusion bags.

### EXAMPLES

The present invention will be specifically described below by Examples and Comparative Examples, but the present invention is not limited by these in any way.

### [Melting Point of Resin]

The melting point of a resin was measured in accordance with ASTM D3418-75. Specifically, differential scanning calorimetry; DSC (Diamond DSC manufactured by PerkinElmer) was used, and the melting point (Tm° C.) was taken as the melting point of the resin.

### [Tensile Modulus]

The tensile modulus was measured in accordance with ASTM D638. Specifically, the tensile modulus was measured using Autograph AG manufactured by SHIMADZU CORPORATION.

### [Oxygen Transmission Rate (OTR)]

The oxygen transmission rate (OTR) was measured in accordance with ASTM D-3985. Specifically, the measurement was performed in a constant temperature and humidity chamber at 23° C. and 50% RH by using OX-TRAN 2/20 manufactured by Mocon, applying a container measurement option, and connecting both ends of a cylindrical molded article having an inner diameter of 9.0 mm φ and a length of 1500 mm, and the amount of oxygen passing through the cylindrical molded article from the outside air was taken as the oxygen transmission rate (mL/pkg (package)·day). In the above measurement, the case of “Failed” during the measurement was evaluated as “leakage”.

### [Cut Surface Fine Appearance]

A cross section of each of tubular molded bodies (tubes) obtained in the Examples and the Comparative Examples was observed using a microscope (manufactured by KEYENCE CORPORATION), and evaluated by the following criteria.

◯: There were no layer cracks or cross-sectional disorder.

X: There were layer cracks and cross-sectional disorder.

### [Smell Retention Property Evaluation]

The mouth of each of the tubular molded bodies obtained in the Examples and the Comparative Examples on one side was closed, and 10 mL of ethanol was placed and hermetically sealed. The cylindrical molded article was placed in a 5 L desiccator in a state in which the tube side surface was horizontal, and hermetically sealed. After the desiccator was stored at 40° C. for 1 day, the degree of an alcohol smell leaking from the cylindrical molded article into the desiccator was evaluated by the following criteria.

◯: There was no alcohol smell at all.

Δ: There was a slight alcohol smell.

X: There was a distinct alcohol smell.

### Example 1

Polypropylene (PP-1; melting point 163° C., tensile modulus 1400 MPa, manufactured by SunAllomer Ltd.) was continuously extruded tubularly using melt extrusion equipment equipped with a tubular die. Then, the extrudate was adjusted to an inner diameter of 9.0 mm φ in a cold water tank with an outer diameter sizing apparatus to obtain a single-layer tube having a thickness of 600 μm. Then, a vapor-deposited layer comprising silicon oxide (SiO₂) was formed on the outer peripheral surface of the obtained single-layer tube using an apparatus having the configuration shown in FIG. 3, to obtain a cylindrical molded article. The formation of the vapor-deposited layer was performed so that by rotating the single-layer tube in the circumferential direction, the vapor-deposited layer was formed on the outer periphery of the single-layer tube.

### Examples 2 to 4

Tubular molded bodies were obtained by the same method as Example 1 except that the thickness of the single-layer tube was changed as shown in Table 1.

### Examples 5 to 7

Tubular molded bodies were obtained by the same method as Example 1 except that as shown in Table 1, a polyamide (PA-1; melting point 196° C., tensile modulus 1900 MPa, manufactured by Ube Industries, Ltd.), a polyamide (PA-2; melting point 220° C., tensile modulus 2100 MPa, manufactured by Ube Industries, Ltd.), and a polyamide (PA-3; melting point 235° C., tensile modulus 2300 MPa, manufactured by MITSUBISHI GAS CHEMICAL COMPANY, INC.) were used instead of polypropylene (PP-1), and the thicknesses were each 600 μm.

### Example 8

A cylindrical molded article was obtained by the same method as Example 1 except that as shown in Table 1, high density polyethylene (HDPE; melting point 141° C., tensile modulus 1100 MPa, manufactured by Asahi Kasei Corporation) was used instead of polypropylene (PP-1), and the thickness was 600 μm.

### Example 9

A cylindrical molded article was obtained by the same method as Example 1 except that as shown in Table 1, polyethylene terephthalate (PET; melting point 252° C., tensile modulus 2200 MPa, manufactured by TEIJIN LIMITED) was used instead of polypropylene (PP-1), and the thickness was 600 μm.

### Example 10

Polypropylene (PP-1) and the polyamide (PA-2) were tubularly coextruded using melt extrusion equipment equipped with a tubular die. At this time, the thickness of the layer composed of polypropylene was made to be 500 μm, and the thickness of the layer composed of the polyamide was made to be 100 μm. Then, the coextrudate was adjusted to an inner diameter of 9.0 mm φ in a cold water tank with an outer diameter sizing apparatus to obtain a two-layer tube having a total thickness of 600 μm. Then, a vapor-deposited layer comprising silicon oxide was formed on the outer peripheral surface of the obtained two-layer tube using an apparatus having the configuration shown in FIG. 3, to obtain a cylindrical molded article.

### Example 11

Polypropylene (PP-1) and an ethylene-vinyl alcohol copolymer (EVOH, melting point 165° C., tensile modulus 2000 MPa, manufactured by KURARAY CO., LTD.) were tubularly coextruded using melt extrusion equipment equipped with a tubular die. At this time, the thickness of the layer composed of polypropylene was made to be 500 μm, and the thickness of the layer composed of the ethylene-vinyl alcohol copolymer was made to be 300 μm. Then, the coextrudate was adjusted to an inner diameter of 9.0 mm φ in a cold water tank with an outer diameter sizing apparatus to obtain a two-layer tube having a total thickness of 800 μm. Then, a vapor-deposited layer comprising silicon oxide was formed on the outer peripheral surface of the obtained two-layer tube using an apparatus having the configuration shown in FIG. 3, to obtain a cylindrical molded article.

### Examples 12 to 13

Tubular molded bodies were obtained as in Example 1 except that as shown in Table 1, vapor-deposited layers comprising aluminum oxide (Al₂O₃) and diamond-like carbon (DLC) instead of silicon oxide were formed to obtain tubular molded bodies.

### Comparative Example 1

A cylindrical molded article was obtained as in Example 1 except that the vapor-deposited layer of silicon oxide was not formed.

### Comparative Example 2

A cylindrical molded article was obtained by the same method as Example 1 except that as shown in Table 1, polypropylene (PP-5, melting point 124° C., tensile modulus 700 MPa, manufactured by SunAllomer Ltd.) was used instead of polypropylene (PP-1).

### Comparative Example 3

A cylindrical molded article was obtained by the same method as Example 1 except that as shown in Table 1, the thickness of polypropylene (PP-1) was 50 μm.

### Comparative Example 4

A cylindrical molded article was obtained by the same method as Example 1 except that as shown in Table 1, low density polyethylene (LDPE, melting point 110° C., tensile modulus 600 MPa, manufactured by Asahi Kasei Corporation) was used instead of polypropylene (PP-1).

### Comparative Example 5

A cylindrical molded article was obtained as in Example 11 except that the vapor-deposited layer of silicon oxide was not formed.

### Comparative Example 6

A cylindrical molded article was obtained as in Example 1 except that instead of the vapor-deposited layer of silicon oxide, aluminum foil was wound around the single-layer tube.

TABLE 1

| | Cylindrical | | | | Cylindrical | | |
|---|---|---|---|---|---|---|---|
| | molded article | | | | molded article | | |
| | configura tion | | | | oxygen | | Smell |
| | tube inside←→outside | | Tensile | Vapor | transmission | Cut surface | retention |
| | (thickness) | | modulus | deposition | rate | fine | property |
| | (melting point Tm) | | [MPa] | species | [mL/pkg · day] | appearance | evaluation |
| Example 1 | PP-1 | | 1400 | SiO₂ | 0.01 | ◯ | ◯ |
| | (600 μm) | | | (PECVD) | | | |
| | (163° C.) | | | | | | |
| Example 2 | PP-1 | | 1400 | SiO₂ | 0.01 | ◯ | ◯ |
| | (1000 μm) | | | (PECVD) | | | |
| | (163° C.) | | | | | | |
| Example 3 | PP-1 | | 1450 | SiO₂ | 0.01 | ◯ | ◯ |
| | (300 μm) | | | (PECVD) | | | |
| | (163° C.) | | | | | | |
| Example 4 | PP-1 | | 1500 | SiO₂ | 0.01 | ◯ | ◯ |
| | (100 μm) | | | (PECVD) | | | |
| | (163° C.) | | | | | | |
| Example 5 | PA-1 | | 1900 | SiO₂ | 0.01 | ◯ | ◯ |
| | (600 μm) | | | (PECVD) | | | |
| | (196° C.) | | | | | | |
| Example 6 | PA-2 | | 2100 | SiO₂ | 0.01 | ◯ | ◯ |
| | (600 μm) | | | (PECVD) | | | |
| | (220° C.) | | | | | | |
| Example 7 | PA-3 | | 2300 | SiO₂ | 0.01 | ◯ | ◯ |
| | (600 μm) | | | (PECVD) | | | |
| | (235° C.) | | | | | | |
| Example 8 | HDPE | | 1100 | SiO₂ | 0.01 | ◯ | ◯ |
| | (600 μm) | | | (PECVD) | | | |
| | (141° C.) | | | | | | |
| Example 9 | PET | | 2200 | SiO₂ | 0.01 | ◯ | ◯ |
| | (600 μm) | | | (PECVD) | | | |
| | (252° C.) | | | | | | |
| Example 10 | PP-1 | PA-2 | 1800 | SiO₂ | 0.01 | ◯ | ◯ |
| | (500 μm) | (100 μm) | | (PECVD) | | | |
| | (163° C.) | (220° C.) | | | | | |
| Example 11 | PP-1 | EVOH | 1800 | SiO₂ | 0.01 | ◯ | ◯ |
| | (500 μm) | (300 μm) | | (PECVD) | | | |
| | (163° C.) | (165° C.) | | | | | |
| Example 12 | PP-1 | | 1400 | Al₂O₃ | 0.01 | ◯ | ◯ |
| | (600 μm) | | | (PECVD) | | | |
| | (163° C.) | | | | | | |
| Example 13 | PP-1 | | 1400 | DLC | 0.01 | ◯ | ◯ |
| | (600 μm) | | | (PECVD) | | | |
| | (163° C.) | | | | | | |
| Comparative | PP-1 | | 1400 | None | 30 | ◯ | X |
| Example 1 | (600 μm) | | | | | | |
| | (163° C.) | | | | | | |
| Comparative | PP-5 | | 700 | SiO₂ | Leakage | X | X |
| Example 2 | (600 μm) | | | (PECVD) | | | |
| | (124° C.) | | | | | | |
| Comparative | PP-1 | | 1400 | SiO₂ | Leakage | X | X |
| Example 3 | (50 μm) | | | (PECVD) | | | |
| | (163° C.) | | | | | | |
| Comparative | LDPE | | 600 | SiO₂ | Leakage | X | X |
| Example 4 | (600 μm) | | | (PECVD) | | | |
| | (110° C.) | | | | | | |
| Comparative | PP-1 | EVOH | 1700 | None | 0.1 | ◯ | X |
| Example 5 | (500 μm) | (100 μm) | | | | | |
| | (163° C.) | (165° C.) | | | | | |
| Comparative | PP-1 | Aluminum | 2500 | None | Leakage | X | X |
| Example 6 | (500 μm) | foil | | | | | |
| | (163° C.) | (250 μm) | | | | | |

The present application claims priority from Japanese Patent Application (Japanese Patent Application No. 2017-154496) filed to the Japan Patent Office on Aug. 9, 2017, the contents of which are hereby incorporated by reference

### INDUSTRIAL APPLICABILITY

The present invention has industrial applicability as a cylindrical molded article having high barrier properties that can be used for various applications.

What is claimed is:

1. A cylindrical molded article comprising:
a cylindrical resin layer comprising a resin having a melting point of 140° C. or more; and
a vapor-deposited layer disposed on an outer peripheral surface of the resin layer,
the vapor-deposited layer comprising at least one selected from the group consisting of silicon oxide, aluminum oxide, and diamond-like carbon, and the cylindrical molded article having a total thickness of 100 μm or more.

2. The cylindrical molded article according to claim 1, wherein the resin constituting the resin layer comprises at least one selected from the group consisting of a polypropylene-based resin, a polyamide-based resin, and a polyethylene terephthalate-based resin, and a tensile modulus of the resin is 800 MPa or more and 3500 MPa or less.

3. A method for manufacturing a cylindrical molded article, comprising a vapor deposition step of vapor-depositing at least one selected from the group consisting of silicon oxide, aluminum oxide, and a hydrocarbon on an outer peripheral surface of a cylindrical resin layer comprising a resin having a melting point of 140° C. or more to form a vapor-deposited layer.

4. The method for manufacturing a cylindrical molded article according to claim 3, wherein in the vapor deposition step, the cylindrical resin layer is rotated in a circumferential direction.

5. A barrier plug comprising a spout body to be attached to a container, and a cylindrical molded article inserted into the spout body,
the cylindrical molded article being the cylindrical molded article according to claim 1, the spout body comprising a polyolefin-based resin.

6. A barrier plug-attached container comprising a container and the barrier plug according to claim 5 attached to the container.

7. An tube for storing ink for accommodating a writing implement ink, the tube for storing ink being the cylindrical molded article according to claim 1.
